(19) United States
(12) Patent Application Publication
(10) Pub. No.: US 2023/0258858 A1
(43) Pub. Date: Aug. 17, 2023

(54) PIXELATED LIGHTING DEVICE

(71) Applicant: DESIGN LED PRODUCTS LIMITED, West Lothian (GB)

(72) Inventors: James GOURLAY, West Lothian (GB); Marius JANKAUSKAS, West Lothian (GB)

(21) Appl. No.: 18/015,234

(22) PCT Filed: Jun. 15, 2021
(86) PCT No.: PCT/GB2021/051500

§ 371 Date: Jan. 9, 2023

(30) Foreign Application Priority Data
Jul. 15, 2020 (GB) 2010904.7

(51) Int. Cl. F21V 8/00

(52) U.S. Cl. CPC G02B 6/0078; G02B 6/0016; G02B 6/0021; G02B 6/0055; G02B 6/0065; G02B 6/0073; G02B 6/0018

(57) ABSTRACT

A pixelated lighting device (8) comprising one or more light sources (10) embedded within a composite light-guide is disclosed. The pixelated lighting device incorporates refractive light barriers (15) to achieve contrast between adjacent pixels (16a, 16b). These features combine to provide a pixelated lighting device with an acceptable contrast ratio and with a very high fill factor. The structure of the pixelated lighting device means that it can be manufactured as a very thin device so making it particularly suited

The present invention relates to the field of lighting and displays, and in particular, to a pixelated lighting device that can be used for illumination, backlighting, signage or display purpose. The described pixelated lighting device finds particular application within the field of transportation e.g. the automotive, train and aerospace industries.

### BACKGROUND TO THE INVENTION

Lighting is a key means of making interior vehicle spaces, where passengers stand or sit during transportation, more attractive and pleasant environments. One of the most effective ways to deliver light into these environments, while saving space, is to backlight the interior surfaces of the vehicles. Additionally, the spatial control (or pixilation) of the light across the surface is important to deliver light only where it is needed. As a result, there is a requirement for a pixelated, low intensity light, to be provided over a large surface area. This uniform low intensity light level is required to keep the glare experienced by passengers being transported within the vehicles to a minimum, whilst also providing a means to attractively decorate and illuminate the interior surfaces.

Due to space and weight constraints within vehicles, any light source solution must be very thin, of the order of −1 mm. In addition, due to vibration and integration constraints, the lightning device must also be capable of being mechanically attached, bonded, joined or moulded onto the internal 3D surface of the vehicle.

A standard technology for producing a pixelated light source across a surface is a Liquid Crystal Display (LCD). Here, light crystal devices act as electrically controlled shutters in front of a non-switching (rectangular) light source. However, over 90% of the light from the light source is lost in the liquid crystal devices, so this is not an energy efficient way to back-illuminate a surface.

A more energy efficient way for providing a pixelated light source, is to produce individual pixels of light. A number of pixelated light source technologies exist which can be employed within the field of transportation. Two such examples are electroluminescent film and organic light emitting diodes (OLED). Both solutions involve an active light emitting material that is required to cover the entire surface to be backlit. Thereafter, the emitted light is broken into individually electrically controllable elements. However, both technologies are expensive, have a low reliability and lifetime and so neither are ideally suited for use as an integrated solution for transportation interiors.

Inorganic light emitting diodes (LEDs) are another common lighting technology employed for transportation lighting. LEDs are small solid state, semiconductor chip-based devices, that can be designed to emit different colours of light, or when used in combination with colour converting materials, to provide white light. LEDs are small points of light, that can be designed into 2D arrays of individual controllable lighting devices. If the pitch of the LEDs is small, then a very effective display technology can be produced, which can then be used for example in large area stadium display applications. However, for low light-level applications, the individual LEDs must be very low power, such as mini-LED or micro-LED. If the spacing between the LEDs is large, then a hot spot of light is observed at the LED position, and this “dotty” appearance is very unattractive.

In order to meet the very thin and homogeneous requirements of automotive surface backlighting, where large spacing between low power LEDs is needed, a range of optics have been required to be employed.

The simplest configuration of optical system employed to achieve the desired pixelated large area, homogeneous lighting surface comprises the use of LED devices in a 2D matrix across a printed circuit board (PCB), then deploying a 2D array of reflective cavities, with each LED in one cavity and then locating a diffuser layer on top of the reflective cavities. This is conventionally known as a pixelated direct-lit LED backlight. An advantage of the pixelated direct-lit LED backlight approach is that each LED is independently addressable, and so a pixelated area light source can be produced. However, such systems require either the LEDs to be very closely packed (as described above), which results in high power density and high costs per area, or the employment of a very thick optical system (e.g. an air gap and or diffuser thickness), which results in such systems being unsuitable for deployment within the limited interior transport spaces. For example, if the LEDs are spaced 20 mm apart, the optical system depth is required to be >20 mm.

It is also known in the art to employ light guides to distribute light from a light source to an area that requires illumination. One known type of light-guide is a planar light-guide. These are plates or panel light-guides, which are typically formed as thin cuboids. Light-guide designs exploit the effects of refraction caused by two materials having different refractive index. In particular, a light-guide transports light from one location to another, by exploiting the effects of total internal reflection experienced by the light propagating within the material when it encounters a boundary surrounding the material. A further useful property of the aforementioned light-guides is their ability to take the light output from an LED and spread it evenly and or change its shape or distribution to achieve a desired result.

An approach is that commonly known as the edge-lit LED backlight approach, is disclosed in US patent publication number US 2004/0136173. Here a machined, printed or moulded, light-guide plate is employed, and the LEDs are mounted along one or more edges. Light is thereafter coupled from the LEDs, into the light-guide plate, before propagating though the light-guide plate. Light extraction features on the surface of the light-guide plate provide a means for the light to exit from the light-guide plate. Correct design of the light extraction features (variation in size, density etc.), gives a homogeneous or uniform backlighting of a surface material or a diffuser layer located across the light-guide plate. A pixelated light source can be produced by the edge-lit LED approach, by forming each pixel consisting of an independently controlled LED in conjunction with a separate light-guide plate. Many of these LED/light-guide plate modules can be mechanically assembled into a 2D matrix of pixels. A limitation of the edge-lit LED approach is that there are many separate opto-mechanical components, resulting in cost, reliability, and quality issues. Pixelated light sources based on an edge-lit LED approach also suffer from low performance limitations i.e. only low switching contrast ratios or low pixel design fill factors are achievable.

Another approach known in the art is that based on a composite light-guide device, see for example international patent publication number WO 2007/138294. Here, LEDs are distributed in a 2D matrix that is embedded within a light-guide structure. The light-guide structure acts to guide the light from the LEDs in the plane of the light-guide structure. Light extraction features inside or on surface of the composite light-guide device are then employed to provide a means for the light to exit the light-guide structure. The design of the light extraction features (variation in size, density etc.) again provides a means for homogeneously or uniformly backlighting a surface material across the light-guide structure.

International patent publication number WO 2007/138294 discloses that the composite light-guide device can be adapted to form independent pixels, see for example FIG. 1 which presents a two-dimensional, cross sectional side view of the described two-pixel lighting device 1. The two pixel lighting device 1 comprise a transparent substrate 2 upon a first surface of which are mounted LEDs 3. A light reflector or absorbing medium 4 is also located upon the first surface of the transparent substrate 2. A transparent layer 5 is then applied to the first surface of the transparent substrate 2. The refractive indices of the transparent substrate 2 and the transparent encapsulating layer 5 are chosen such that light 6 generated by the LEDs 3 is trapped and guided, via optical refraction and total internal reflection, within the formed composite light-guide structure. The presence of the light reflector or absorbing medium 4 provides controlled optical isolation within the device 1 and thus allows the formation of two light independent pixels 7a and 7b.

Light extraction features (not shown) on one or more interfaces of the transparent layers 2 and 5 or, on one or both of their external surfaces, allows for the total internal reflection condition to be broken and for the light 6 to escape from the two pixel lighting device 1. The spatial or angular control of the light escaping, depends on the nature of the light extraction features, and so allows for the design of a variety of lighting and display products.

The use of a physical barrier in the form of the light reflector or absorbing medium 4 within the two pixel lighting device 1 provide a device that has greater switching contrast ratios and pixel design fill factors when compared with those devices based on an edge-lit LED approach. However, to achieve these improved contrast levels the light reflector or absorbing medium 4 is required to be around 1 mm to 2 mm wide which reduces the fill factor that can be achieved with such pixel lighting device 1. The incorporation of the light reflector or absorbing medium 4 within the two pixel lighting device 1 also significantly increases the complexity, and thus the cost, of manufacturing such devices 1.

### SUMMARY OF THE INVENTION

It is therefore an object of an embodiment of the present invention to provide an alternative pixelated lighting device to those known in the art.

A further object of an embodiment of the present invention is to provide a pixilated lighting device which is simpler to manufacture than those pixelated lighting devices known in the art.

A yet further object of an embodiment of the present invention is to provide a pixilated lighting device which provides a higher fill factor and contrast ratio than those pixelated lighting devices known in the art.

According to a first aspect of the present invention there is provided a pixelated lighting device the pixelated lighting device comprising:

a transparent substrate upon a first surface of which is mounted one or more light sources;

a transparent encapsulating layer arranged to encapsulate the one or more light sources upon the first surface and forming a composite light-guide with the transparent substrate for guiding light produced by the one or more light sources, and

one or more refractive light barriers wherein the one or more refractive light barriers separate the pixelated lighting device into two or more pixels.

The above arrangement provides a pixelated lighting device which is a higher fill factor and contrast ratio than those pixelated lighting devices known in the art.

Preferably, the one or more refractive light barriers comprise a gap within the transparent encapsulating layer. The gap preferably has a width between 50 μm to 100 μm. This provides a pixelated lighting device which is simpler to manufacture than those pixelated lighting devices known in the art.

Optionally one or more edges of the gap comprises an angled surface feature. This embodiment provides a means for enhancing the light retained within the associated pixel.

Alternatively, one or more edges of the gap comprises a curved surface feature. This embodiment provides an alternative means for enhancing the light retained within the associated pixel.

Optionally, a first reflective or absorbing feature is located within the gap. An adhesive may be employed to attach the first reflective or absorbing feature within the gap. The one or more refractive light barriers may further comprise a second reflecting or absorbing feature. The second reflecting or absorbing feature may be located on an external surface of the composite light-guide.

In an alternative embodiment, the first surface of the transparent substrate comprises a specular or non-specular reflective surface. This arrangement provides a means for reducing the leakage of the light between independent pixels of the pixelated lighting device.

In an alternative embodiment the one or more refractive light barriers comprise a curved surface profile located within the transparent substrate. The one or more refractive light barrier may further comprise a corresponding curved surface profile located within the transparent encapsulation layer. Optionally, the one or more refractive light barriers further comprises a reflecting or absorbing feature. The reflecting or absorbing feature may be located on an external surface of the composite light-guide. Alternatively, or in addition, the reflecting or absorbing feature may be located within the composite light-guide.

Most preferably the transparent substrate comprises a first refractive index and the transparent encapsulating layer comprises a second refractive index wherein the second refractive index is less than the or equal to the first refractive index.

Most preferably the pixelated lighting device further comprises one or more light extraction features arranged to direct light generated by the one or more light sources towards an output surface of the pixelated lighting device.

Optionally, the one or more light extraction features are located on a second surface of the transparent base substrate, the second surface being opposite to the first surface.

The one or more light extraction features may be located on the specular or non-specular reflective surface.

According to a second aspect of the present invention there is provided a method of manufacturing a pixelated lighting device the method comprising:

providing a transparent substrate;

mounting one or more light sources upon a first surface of the transparent substrate;

providing a transparent encapsulating layer arranged to encapsulate the one or more light sources upon the first surface and form a composite light-guide with the transparent substrate for guiding light produced by the one or more light sources; and

providing one or more refractive light barriers wherein the one or more refractive light barriers separate the pixelated lighting device into two or more pixels.

Preferably, providing the one or more refractive light barriers comprises providing a gap in the transparent encapsulation layer. The gap may be provided by cutting and or removing a volume of the transparent encapsulation layer.

Optionally, providing a gap in the transparent encapsulation layer comprises providing one or more edges of the gap with an angled surface feature.

Alternatively, providing a gap in the transparent encapsulation layer comprises providing one or more edges of the gap with a curved surface feature.

Optionally, providing the one or more refractive light barriers comprises providing a first reflective or absorbing feature within the gap.

Optionally the first reflective or absorbing feature is attached within the gap with an adhesive.

Optionally, providing the one or more refractive light barriers comprises providing a second reflecting or absorbing feature. The second reflecting or absorbing feature may be provided on an external surface of the composite light-guide.

The method of manufacturing a pixelated lighting may further comprise making the first surface of the transparent substrate a specular or non-specular reflective surface.

Alternatively, providing the one or more refractive light barriers comprises providing a curved surface profile within the transparent substrate. Providing the one or more refractive light barriers may further comprise providing a corresponding curved surface profile within the encapsulation layer. Optionally, the one or more refractive light barriers may be further provided with a reflecting or absorbing feature. The reflecting or absorbing feature may be provided on an external surface of the composite light-guide. Alternatively, or in addition, the reflecting or absorbing feature may be provided within the composite light-guide.

The method of manufacturing a pixelated lighting may further comprise providing one or more light extraction features arranged to direct light generated by the one or more light sources towards an output surface of the pixelated lighting device.

Optionally, the one or more light extraction features are provided on a second surface of the transparent base substrate, the second surface being opposite to the first surface.

The one or more light extraction features may be provided on the specular or non-specular reflective surface.

Embodiments of the second aspect of the invention may comprise features to implement the preferred or optional features of the first aspect of the invention or vice versa.

According to a third aspect of the present invention there is provided a pixelated lighting device the pixelated lighting device comprising:

a transparent substrate upon a first surface of which is mounted one or more light sources;

a transparent encapsulating layer arranged to encapsulate the one or more light sources upon the first surface and forming a composite light-guide with the transparent substrate for guiding light produced by the one or more light sources, and

one or more reflective or absorbing light barriers wherein the one or more reflective or absorbing light barriers separate the pixelated lighting device into two or more pixels wherein, the pixelated lighting device further comprise one or more gaps formed through the transparent substrate at the location of the one or more reflective or absorbing light barriers,

This arrangement acts to reduces the leakage of the light between independent pixels of the pixelated lighting device.

Preferably, the one or more gaps formed through the transparent substrate extend into the reflective or absorbing light barrier.

Optionally, a reflective or absorbing feature is located within the one or more gaps.

Embodiments of the third aspect of the invention may comprise features to implement the preferred or optional features of the first and or second aspects of the invention or vice versa.

### BRIEF DESCRIPTION OF THE DRAWINGS

There will now be described, by way of example only, various embodiments of the invention with reference to the drawings, of which:

FIG. 1 presents a two-dimensional, cross sectional side view of a pixelated composite light-guide device known in the art;

FIG. 2 presents a two-dimensional, cross sectional side view of a pixelated composite light-guide device in accordance with an embodiment of the present invention;

FIG. 3 presents a two-dimensional, cross sectional side view, of a pixelated lighting device wherein an LED is arranged to edge light two transparent guide sections;

FIG. 4 presents a two-dimensional, cross sectional side view, of a pixelated lighting device wherein an LED is embedded within one of the two transparent guide sections;

FIG. 5 presents a two-dimensional, cross sectional side view or a ray trace simulation, showing how the light moves between the two light-guide sections of the pixelated lighting device of FIG. 3;

FIG. 6 presents a two-dimensional, cross sectional side view or a ray trace simulation, showing how the light moves between the two light-guide sections of the pixelated lighting device of FIG. 4;

FIG. 7 presents a two-dimensional, top elevation of an alternative refractive barrier of the pixelated lighting device;

FIG. 8 presents a two-dimensional, side elevation of a further alternative refractive barrier of the pixelated lighting device;

FIG. 9 presents two-dimensional, cross sectional side views of yet further alternative refractive barriers of the pixelated lighting device;

FIG. 10 presents a two-dimensional, side view showing a yet further alternative refractive barrier of the pixelated lighting device;

FIG. 11 presents an alternative composite light-guide for the pixelated lighting device;

FIG. 12 presents a two-dimensional, cross sectional side view of an alternative pixelated lighting device based on the alternative composite light-guide of FIG. 11;

FIG. 13 presents a top view of a 2D pixelated lighting device comprising quadrilateral shaped pixels;

FIG. 14 presents a top view of a 2D pixelated lighting device comprising hexagonal shaped pixels; and

FIG. 15 presents a top view of a 2D pixelated lighting device comprising hexagonal shaped pixels.

FIG. 16 presents a two-dimensional, cross sectional side view of an alternative means to reduce light leakage employed within the pixelated composite light-guide device of FIG. 1;

In the description which follows, like parts are marked throughout the specification and drawings with the same reference numerals. The drawings are not necessarily to scale and the proportions of certain parts have been exaggerated to better illustrate details and features of embodiments of the invention.

The terms “transparent” and “absorbing” employed throughout the following description relate to the optical properties of particular components of the device relative to the wavelength of the light generated by the incorporated light sources.

### DETAILED DESCRIPTION OF PREFERRED EMBODIMENTS

FIG. 2 presents a two-dimensional, cross sectional side view of a pixelated lighting device 8 in accordance with an embodiment of the present invention. The pixelated lighting device 8 can be seen to comprise a transparent substrate 9 upon a first surface of which are mounted light sources 10 in the form of LEDs. A transparent encapsulating layer 11 is located on the first surface of the substrate 2 and is arranged to encapsulate the LEDs 10 within a composite light-guide structure formed with the transparent substrate 9.

Preferably the refractive indices of the transparent substrate 9 (nₛ) and the transparent encapsulating layer 11 (nₑ) are chosen such that satisfy the inequality nₛ≥nₑ. As a result, light 12 generated by the LEDs 10 is trapped and guided, via optical refraction and total internal reflection, within the composite light-guide structure formed by the transparent substrate 9 and the transparent encapsulating layer 11.

Light extraction features 13 are located on a second surface of the transparent substrate 9 i.e. the side opposite to the first surface of the transparent substrate 9. The light extraction features 13 allow for the total internal reflection condition to be broken and the light 12 to escape from the pixelated lighting device 8 via an light output surface 14 i.e. the surface of the transparent encapsulating layer 11 opposite to the first surface of the transparent substrate 9. The spatial or angular control of the light escaping, depends on the nature of the light extraction features 13, and so allows for the design of a variety of lighting and display products based on the pixelated lighting device 8.

A refractive barrier 15 is formed by having a gap within the transparent encapsulating layer 11 thus form two distinct transparent guide sections 11a and 11b. Preferably the gap 15 is formed by cutting, or otherwise removing a volume of the transparent encapsulating layer 11. The gap 15 therefore forms a region with refractive index n_{b}=1, which is less than the refractive indices of the transparent substrate 9 (ns) and the transparent encapsulating layer 11 (nₑ). In this way the two sections of the transparent encapsulating layer 11 define two light independent pixels 16a and 16b within the pixelated lighting device 8.

The gap 15 preferably has a width between 50 μm to 100 μm. Significantly, the gap 15 does not enter the transparent substrate 9, and so the independent pixels 16a and 16b remain mechanically connected

In the presently described embodiment, the light 12 comprise a light emitting diode (LED) electrically and mechanically mounted onto a printed circuit board (PCB) or other printed electrical tracking on the transparent substrate 9. Optionally, the LEDs are of a type designed to emit light from all five surfaces that are not in contact with the electrical tracking. A Chip Scale Package (CSP) LED (e.g. an OSRAM CHIPLED® 0402, LW QH8G that emits white light) or an RGB LED such as Everlight EAST1616RGBA0 are two example LEDs 10 that may be incorporated within the pixelated lighting device 8. Both these LEDs 10 are low power and have dimension of −1 mm.

The transparent substrate 9 can be selected from a variety of transparent films such as glass, polyester, polycarbonate, or acrylic. Optionally, Melinex 506, polyester from the company Dupont can be used. The transparent encapsulation layer 11 that embeds the light sources 10 may be made from a layer of transparent material such as acrylic, polymethyl methacrylate (PMMA), polycarbonate, silicone or polyurethane.

The composite light-guide (consisting of layers 9 and 11) may have a thickness of up to 3 mm depending on the particular LEDs 10 employed within the pixelated lighting device 8.

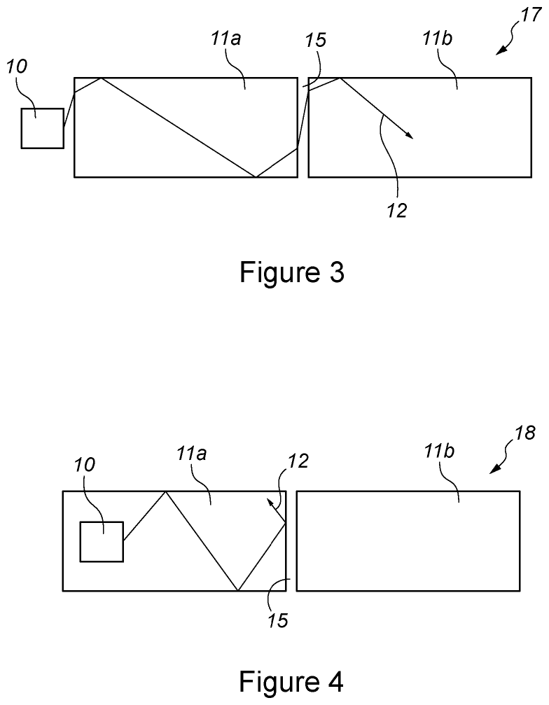

An explanation of why the fill factor and contrast ratio of pixelated lighting device 8, when compared with the pixelated lighting devices known in the art will now be provided with reference to FIGS. 3 to 6.

FIG. 3 presents a two-dimensional, cross sectional side view, of a pixelated lighting device 17 wherein the LED 10 is arranged to edge light two transparent guide sections 11a and 11b. Light 12 emitted from the LED 10, is coupled into the first transparent guide section 11a and guided towards the second transparent guide section 11b. At the refractive barrier 15 located between the two transparent guide sections 11a and 11b, the majority of the light couples from the first transparent guide section 11a into the second transparent guide section 11b. Therefore, there is no significant contrast (different light levels) observed between the two transparent guide sections 11a and 11b when the single light source 10 is switched on.

By way of comparison, FIG. 4 presents a two-dimensional, cross sectional side view, of a pixelated lighting device 18 wherein the LED 10 is embedded within the first transparent guide section 11a. In this situation, light 12 emitted from the LED 10 with a high incidence is trapped within the first transparent guide section 11a and is not transferred to the second transparent guide section 11b. Therefore, there is an observable contrast between the first transparent guide section 11a and the second transparent guide section 11b when the single light source 10 is switched on.

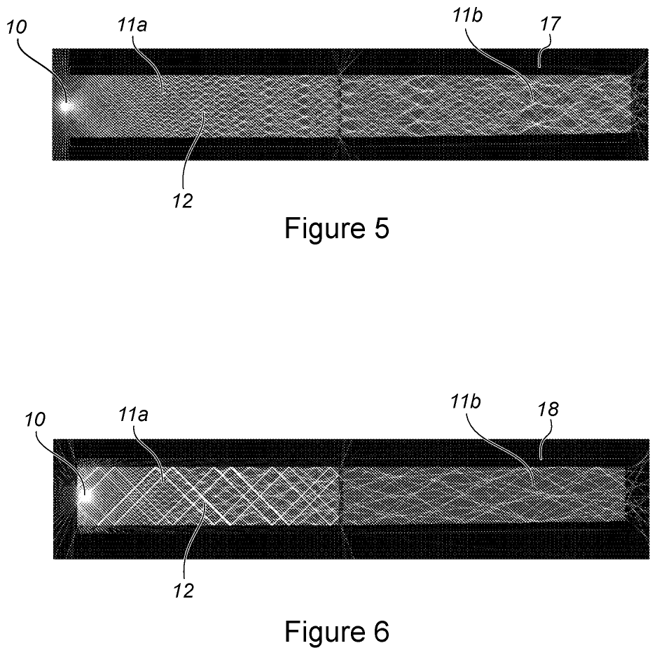

FIG. 5 presents a two-dimensional, cross sectional side view or a ray trace simulation, showing how the light moves between the two light-guide sections 11a and 11b of the pixelated lighting device 17 of FIG. 3. In a similar manner, FIG. 6 presents a two-dimensional, cross sectional side view or a ray trace simulation, showing how the light moves between the two light-guide sections 11a and 11b of the pixelated lighting device 18 of FIG. 4. FIGS. 5 and 6 clearly demonstrate that by embedding the LED 10 within the first transparent guide section 11a, a larger proportion of the light 12 emitted by the LED 10 is retained the first transparent guide section 11a i.e. denser light rays can be observed in the first transparent guide section 11a of FIG. 6. This results in an observable contrast between the first transparent guide section 11a and the second transparent guide section 11b, which is not present within the ray trace simulation of FIG. 5. FIGS. 6 thus demonstrate that the refractive barrier 15 can be employed to deliver functioning independent pixels 16a and 16b within the pixelated lighting device 8 that exhibits measurable contrast ratio between adjacent pixels 16a and 16b.

The applicants have also found that the amount of light 12 that leaks from the first transparent guide section 11a into the second transparent guide section 11b is inversely proportional to the separation between these sections i.e. the width of the refractive barrier 15. Therefore, control of the contrast pixels 16a and 16b can be obtained by controlling the width of the refractive barrier 15, the greater the width of the refractive barrier 15 the less light 12 leaks from the first transparent guide section 11a into the second transparent guide section 11b.

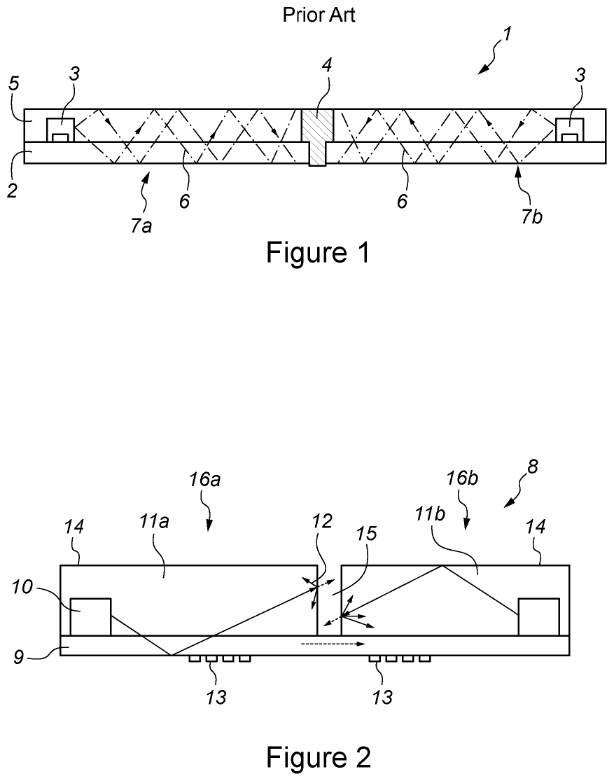

A further point to note is that the width of the gap 15 is much less than the width of the light reflector or absorbing medium 4 employed in the prior art system of FIG. 1. As a result the pixelated lighting device 8 exhibits a much higher fill factor than two pixel lighting device 1.

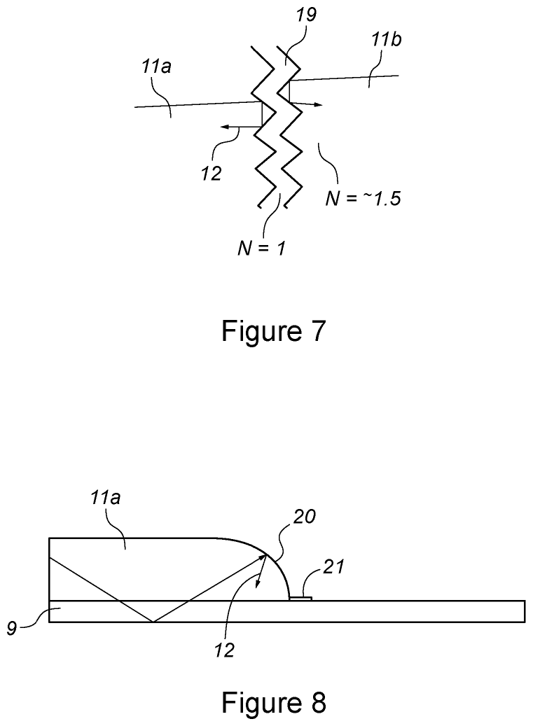

The applicants have also found a number of alternative embodiments for the refractive barrier 15 of the pixelated lighting device 8 which can further enhance the light retaining properties of the pixels 16a and 16b. For example, FIG. 7 shows a plan elevation of the gap c where an angled surface feature 19 is provide on the ends of first 11a and the second 11b transparent guide sections that define the gap 15. The angled surface features 19 can be produced at a microscopic scale i.e. at 10s of microns, or up to a macroscopic scale i.e. at around 1 mm. The angled surface features 19 functions in a similar manner to that of commonly used corner cube reflectors and thus acts to enhance the light retained within the respective transparent guide sections 11a and 11b.

FIG. 8 presents a side view of an alternative embodiment of the refractive barrier 15. In this embodiment, the first transparent guide section 11a comprises a curved surface features 20 at the refractive barrier 15. The curved surface feature 20 again acts to enhance the light 12 retained in the first transparent guide section 11a thus reducing the level of light coupled into the second transparent guide section 11b. The curved surface feature 20 can be formed at the time of producing the transparent encapsulation layer 11.

One such method is to form a low energy surface chemical region 21 on the first surface of the substrate 9. The low energy surface chemical region 21 acts to stop the flow of the liquid transparent polymer employed to produce the transparent encapsulation layer 11, and the resulting meniscus forms a curved surface when the transparent polymer is cured.

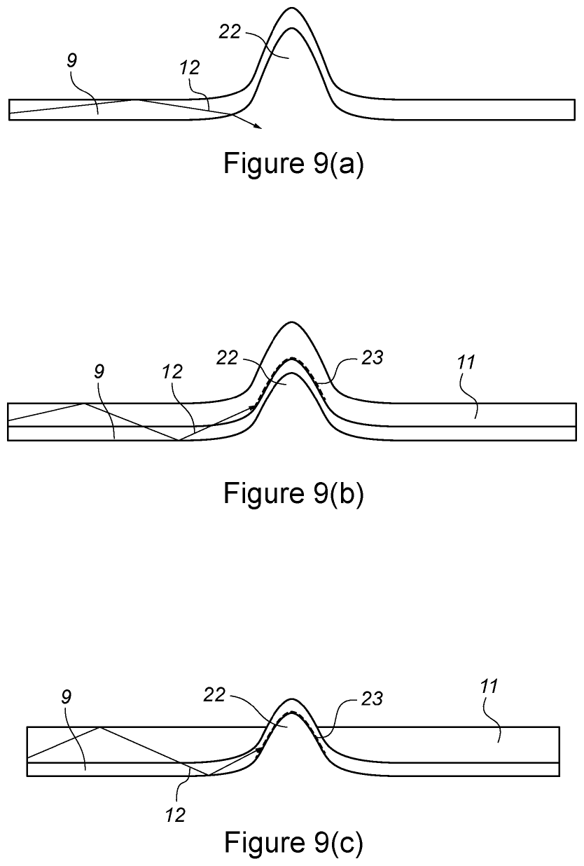

FIG. 9 presents a side view of further alternative embodiments of the refractive barrier 15. In these embodiments the refractive barrier 22 is formed by changing the surface profile of the light-guide structure at the region where the refractive barrier is required. As can be seen from FIG. 9(a) this can be achieved by introducing a curved surface profile to the transparent substrate 9. A corresponding curved surface profile may (see FIG. 9(b)), or may not (see FIG. 9(c)) be introduced to the transparent encapsulation layer 11. The physics of how the refractive barrier 22 works is similar to the effect seen when bending optical fibres. Light losses in optical fibres are increased with reduced bending radius, because the total internal reflection conditions are altered. The applicants have found that the functionality of the refractive barrier 22 can be further enhanced by the introduction of reflecting or absorbing features 23 on the surface (see FIG. 9(c)) or within the composite light-guide structure (see FIG. 9(b)).

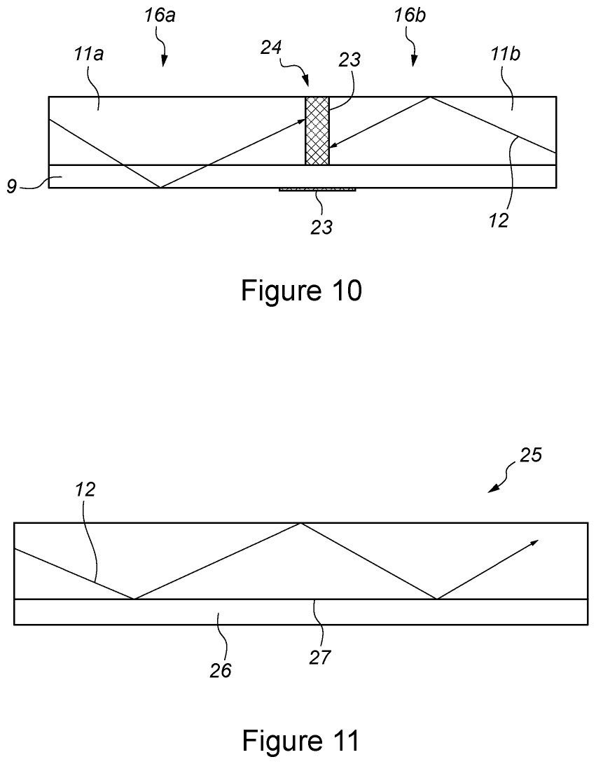

FIG. 10 presents a side view of a yet further alternative embodiment of the refractive barrier 15. In this embodiment, the functionality of the refractive barrier 24 is further enhanced by incorporating reflective or absorbing features 23, such as white or silver ink or other polymers, placed within the gap 15, and or on one or more of the layers or surfaces of the composite light-guide.

In all of the above described embodiments the refractive barriers are formed without making any cuts in the transparent substrate 9. This is done to ensure that the pixelated lighting device 8 does not separate into individual pixel 16. However, in the pixelated lighting device 8 structures based on the design shown in FIG. 2, there will be a leakage of light 12 by the light-guiding path through the layer of the transparent substrate 9.

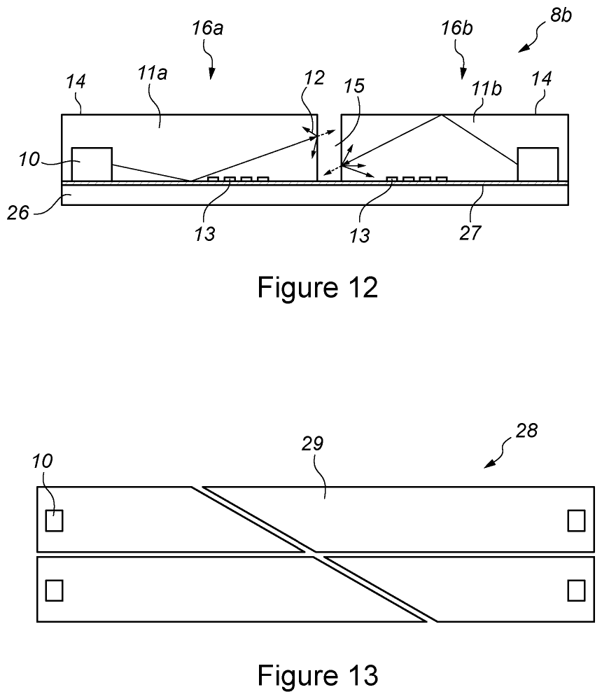

FIG. 11 presents an alternative composite light-guide 25 that can be employed to reduce the leakage of the light 12 between the independent pixels 16a and 16b of the pixelated lighting device 8b presented in FIG. 12. This embodiment is similar to that discussed above with respect to FIG. 2, however the transparent substrate 9 has been replaced with a substrate 26 having a first surface that comprises a specular reflective surface 27.

This arrangement results in additional manufacturing cost, but produces a pixelated lighting device 8b, that does not allow light 12 to propagate through the substrate 26 and thus prevents leakage of the light 12 between the independent pixels 16a and 16b. The specular reflective surface 27 may be produced by a reflective metal, such as silver, or from dielectric layers, such in the product 3MTM Enhanced Specular Reflector (ESR). A non-specular reflector can also be deployed but achieving pixel spatial uniformity is more difficult because the light is not guided effectively with a non-specular reflective surface. Light extraction features 13 can be located on the specular reflective surface 27. For example, non-specular white ink dots, patterned on the specular reflective surface 27 would control the spatial uniformity of the extracted light from the light output surfaces 14 of the independent pixels 16a and 16b.

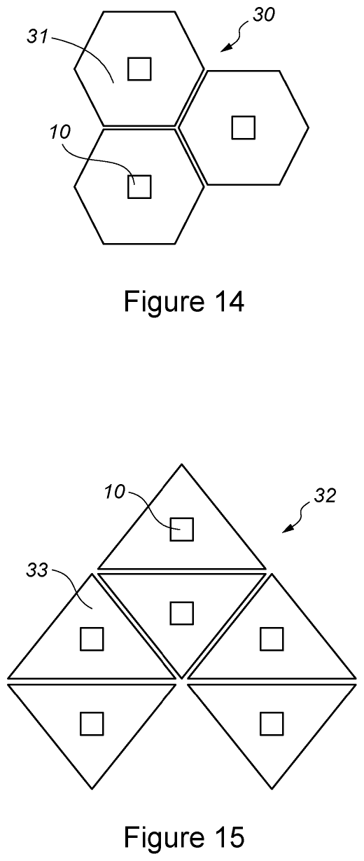

The flexibility of the present invention will now be demonstrated with reference to FIGS. 13 to 15. In particular, FIG. 13 presents a top view of a 2D pixelated lighting device 28 comprising four quadrilateral shaped pixels 29; FIG. 14 presents a top view of a 2D pixelated lighting device 30 comprising three hexagonal shaped pixels 31; and FIG. 15 presents a top view of a 2D pixelated lighting device 32 comprising six triangular shaped pixels 33.

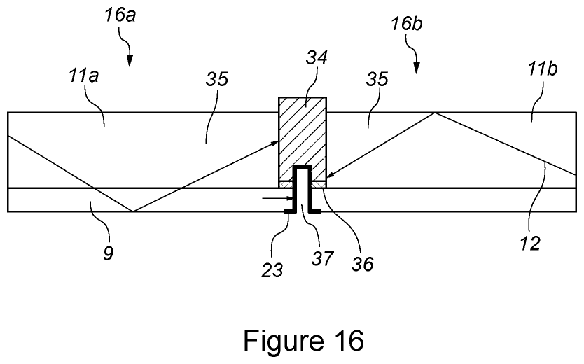

FIG. 16 presents a two-dimensional, cross sectional side view of an alternative means to reduce light leakage employed within a pixelated composite light-guide device 1 of the type presented in FIG. 1. In this embodiment the reflective or absorbing features 34 comprises a white polymer sheet, produced with perforations or holes 35. The reflective or absorbing features 34 is attached to the substrate 9 by a lamination adhesive 36 to define the two independent pixels 16a and 16b. The transparent encapsulation layer 11 is then applied and is introduced into the holes 35 in the reflective or absorbing features 23. A gap 37 is then cut in the transparent substrate 9, and preferably through the lamination adhesive 36 and into the reflective or absorbing features 23. The gap 37 is made while ensuring that the pixelated lighting device 1 does not separate into individual pixels 16. The mechanical strength of the pixelated lighting device 1 is maintained by the interaction of the reflective or absorbing features 34 with the lamination adhesive 36 and transparent encapsulation layer 11 locating with the holes 35.

In a similar manner to that described above, the gap 37 acts as a refractive barrier within the transparent substrate 9 and so reduces the leakage of the light 12 between the independent pixels 16a and 16b and so allows for an increase in the contrast between the independent pixels 16a and 16b of the pixelated lighting device 1. A further reflective or absorbing features 23, such as white or black ink, may then be printed within the gap 37. This arrangement acts to further reduces the leakage of the light 12 between the independent pixels 16a and 16b.

The present invention provides several alternative pixelated lighting devices, capable of providing low intensity light level over a large surface area, compared to those known in the art.

A significant advantage of the present invention is that the pixelated lighting devices can be made much thinner than those devices known in the art while retaining the attractive features of high contrast ratio and high fill factor.

The disclosed pixel lighting devices are also cheaper to manufacture, and due to their integrated nature, have a higher reliability and lifetime, than alternative solutions known in the art.

Since the pixel lighting devices comprise a plurality of individual light sources, they exhibit the advantage that each light source can be made independently addressable, and so a pixelated area light source can be produced.

As a result of the above described advantages, the pixelated lighting devices of the present invention find particular application within the field of transportation e.g. the automotive, train and aerospace industries where there is a requirement for a thin, robust device that is capable of being mechanically attached, bonded, joined or moulded onto the internal surface of the vehicle.

A pixel lighting device comprising one or more light sources embedded within a composite light-guide is disclosed. The pixel light device incorporates refractive light barriers to achieve contrast between adjacent pixels. These features combine to provide a pixel lighting device with an acceptable contrast ratio and with a very high fill factor. The structure of the pixel lighting device means that it can be manufactured as a very thin device so making it particularly suited for use within the field of transportation. Throughout the specification, unless the context demands otherwise, the terms “comprise” or “include”, or variations such as “comprises” or “comprising”, “includes” or “including” will be understood to imply the inclusion of a stated integer or group of integers, but not the exclusion of any other integer or group of integers. Furthermore, unless the context demands otherwise, the term “or” will be interpreted as being inclusive not exclusive.

The foregoing description of the invention has been presented for the purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A pixelated lighting device the pixelated lighting device comprising:
a transparent substrate upon a first surface of which is mounted one or more light sources;
a transparent encapsulating layer arranged to encapsulate the one or more light sources upon the first surface and forming a composite light-guide with the transparent substrate for guiding light produced by the one or more light sources, and
one or more refractive light barriers wherein the one or more refractive light barriers separate the pixelated lighting device into two or more pixels.

2. A pixelated lighting device as claimed in claim 1 wherein the one or more refractive light barriers comprise a gap within the transparent encapsulating layer.

3. A pixelated lighting device as claimed in claim 2 wherein the gap has a width between 50 μm to 100 μm and/or wherein one or more edges of the gap comprises an angled surface feature or a curved surface feature.

4. (canceled)

5. A pixelated lighting device as claimed in claim 2 wherein a first reflective or absorbing feature is located within the gap and/or the pixelated lighting device further comprises a second reflecting or absorbing feature located on an external surface of the composite light-guide.

6. (canceled)

7. A pixelated lighting device as claimed in claim 1 wherein the first surface of the transparent substrate comprises a specular or non-specular reflective surface.

8. A pixelated lighting device as claimed in claim 1 wherein the one or more refractive light barriers comprise a curved surface profile located within the transparent substrate.

9. A pixelated lighting device as claimed in claim 6 wherein the one or more refractive light barrier further comprises a corresponding curved surface profile located within the transparent encapsulation layer and/or wherein the one or more refractive light barriers further comprises a reflecting or absorbing feature, the reflecting or absorbing feature being located on an external surface of the composite light-guide or within the composite light-guide.

10. (canceled)

11. A pixelated lighting device as claimed in claimed in claim 1, wherein the transparent substrate comprises a first refractive index and the transparent encapsulating layer comprises a second refractive index wherein the second refractive index is less than or equal to the first refractive index.

12. A pixelated lighting device as claimed in claimed in any of the preceding claims claim 1 wherein the pixelated lighting device further comprises one or more light extraction features arranged to direct light generated by the one or more light sources towards an output surface of the pixelated lighting device.

13. A pixelated lighting device as claimed in claimed in claim 12 wherein the one or more light extraction features are located on a second surface of the transparent base substrate, the second surface being opposite to the first surface and/or wherein the one or more light extraction features are located on the specular or non-specular reflective surface.

14. (canceled)

15. A method of manufacturing a pixelated lighting device the method comprising:
providing a transparent substrate;
mounting one or more light sources upon a first surface of the transparent substrate;
providing a transparent encapsulating layer arranged to encapsulate the one or more light sources upon the first surface and form a composite light-guide with the transparent substrate for guiding light produced by the one or more light sources; and
providing one or more refractive light barriers wherein the one or more refractive light barriers separate the pixelated lighting device into two or more pixels.

16. A method of manufacturing a pixelated lighting device as claimed in claim 15 wherein providing the one or more refractive light barriers comprises providing a gap in the transparent encapsulation layer.

17. A method of manufacturing a pixelated lighting device as claimed in claim 16 wherein the gap is provided by cutting and or removing a volume of the transparent encapsulation layer.

18. A method of manufacturing a pixelated lighting device as claimed in claim 16 wherein providing a gap in the transparent encapsulation layer comprises providing one or more edges of the gap with an angled surface feature or a curved surface feature.

19. A method of manufacturing a pixelated lighting device as claimed in claim 16 wherein providing the one or more refractive light barriers comprises providing a first reflective or absorbing feature within the gap.

20. A method of manufacturing a pixelated lighting device as claimed in claim 15 wherein the method further comprises making the first surface of the transparent substrate a specular or non-specular reflective surface.

21. A method of manufacturing a pixelated lighting device as claimed in claim 15 wherein providing the one or more refractive light barriers comprises providing a curved surface profile within the transparent substrate.

22. A method of manufacturing a pixelated lighting device as claimed in claim 21 wherein providing the one or more refractive light barriers further comprises providing a corresponding curved surface profile within the encapsulation layer and/or the one or more refractive light barriers are further provided with a reflecting or absorbing feature on an external surface of the composite light-guide or within the composite light-guide.

23. (canceled)

24. A method of manufacturing a pixelated lighting device as claimed in claim 15 wherein the method further comprises providing one or more light extraction features arranged to direct light generated by the one or more light sources towards an output surface of the pixelated lighting device.

25. A method of manufacturing a pixelated lighting device as claimed in claim 24 wherein the one or more light extraction features are provided on a second surface of the transparent base substrate, the second surface being opposite to the first surface or are provided on the specular or non-specular reflective surface.
